(19) United States
(12) Patent Application Publication
(10) Pub. No.: US 2026/0095426 A1
(43) Pub. Date: Apr. 2, 2026

(54) AUTOMATED INTERACTION-SPECIFIC CALENDARING WITHIN A MESSAGING PLATFORM

(71) Applicant: WhatsApp, LLC, Menlo Park, CA (US)

(72) Inventor: Arun Karthick Manickam Alagar Muthumanickam, Lynnwood, WA (US)

(73) Assignee: WhatsApp, LLC, Menlo Park, CA (US)

(21) Appl. No.: 19/347,231

(22) Filed: Oct. 1, 2025

Related U.S. Application Data
(60) Provisional application No. 63/702,554, filed on Oct. 2, 2024.

(51) Int. Cl. H04L 51/046; G06Q 10/1093; G06Q 30/0251

(52) U.S. Cl. CPC H04L 51/046; G06Q 10/1093; G06Q 30/0251

(57) ABSTRACT

Embodiments are disclosed for automated interaction-specific calendaring within a messaging platform. In one example, a computer-implemented method can include monitoring an interaction performed within a messaging platform, the interaction associated with a user of the messaging platform, extracting, concurrently with the monitoring, using a machine learning model, first event data from the monitored interaction, and generating, using the first event data, a first calendar entry in an interaction-specific calendar, the interaction-specific calendar maintained within the messaging platform.

### TECHNICAL FIELD

The present disclosure generally relates to messaging platforms, and more particularly to automated interaction-specific calendaring within a messaging platform.

### BACKGROUND

Messaging technology is synchronous computer-mediated communication involving real-time message transmission from one party to another. Messages include one or more of text, emojis, voice, and video, and can be exchanged among two parties or a larger group. A messaging platform is a system that implements message communication among users of the messaging platform. For example, users of a messaging platform might use the platform to converse using voice only, over video, or text each other. Users typically interact with a messaging platform using a software application (e.g., executing on a mobile device) or a website.

Although a standalone calendaring capability and calendaring integrated within electronic mail applications are presently available, calendaring is not integrated with existing messaging platforms and thus a user’s calendar cannot be automatically updated based on the user’s messaging activity. Further, a user is likely to be a member of many chat groups (i.e., groups exchanging messages with each other), with different combinations of participants. As each group exchanges messages and makes plans, it is difficult for a user to keep track of who in which group is doing what, particularly as plans and circumstances change. As well, many users, including both consumers and businesses, use existing messaging platforms for all of their communications needs, bypassing email and traditional telephone services. Thus, there is a need for a calendaring capability within a messaging platform, with an ability to automatically generate and update calendar events based on a user’s interactions on the messaging platform.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments.

Appendix A which is incorporated herein by reference, includes drawings, examples, and/or other disclosures which provide details and further understanding of various aspects of the subject technology.

FIG. 1 illustrates a network architecture used to implement automated interaction-specific calendaring within a messaging platform, according to some embodiments.

FIG. 2 is a block diagram illustrating details of a system for automated interaction-specific calendaring within a messaging platform, according to some embodiments.

FIG. 3 depicts a block diagram of an example configuration for automated interaction-specific calendaring within a messaging platform, in accordance with an illustrative embodiment.

FIG. 4 depicts an example of automated interaction-specific calendaring within a messaging platform, in accordance with an illustrative embodiment.

FIG. 5 depicts a flowchart of an example process for automated interaction-specific calendaring within a messaging platform. in accordance with an illustrative embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

Embodiments of the present disclosure address the above identified problems by implementing automated interaction-specific calendaring within a messaging platform. In particular, an embodiment monitors an interaction performed in a messaging application, the interaction associated with a user of the messaging application; extracts, concurrently with the monitoring, using a machine learning model, first event data from the monitored interaction; and generates, using the first event data, a first calendar entry in an interaction-specific calendar, the interaction-specific calendar maintained within the messaging application.

An embodiment monitors an interaction performed within a messaging platform. The interaction is associated with a user of the messaging platform. In one embodiment, the interaction includes content recommended for the user by a recommendation engine of the messaging platform. In another embodiment, the interaction includes content sent via the messaging platform between the user and another user or group of users. In one embodiment, content associated with a user is content the user actually views (both sent and received). In another embodiment, content associated with a user also includes content viewed by an associate of the user (e.g., a direct or higher-degree connection of the user, or another user the first user has previously interacted with). Another embodiment includes a control with which the user or an administrator can select which content is monitored for analysis and extraction in a manner described herein. Content includes any combination of text and other media (optionally converted to text for monitoring and analysis purposes) for which the user of the messaging platform has opted into the monitoring.

Concurrently with the monitoring, an embodiment uses a machine learning model to extract event data from the monitored interaction. Event data is data usable to generate a calendar entry, for example when an event is to occur, where the event is to occur, a topic or purpose of the event, one or more participants in the event, and the like. Machine learning models to convert audio and video to text for analysis are presently available, as are machine learning models to analyze text and extract event data.

Using the extracted event data, an embodiment generates a calendar entry in an interaction-specific calendar maintained within the messaging platform. An interaction-specific calendar is a calendar specific to one interaction on the messaging platform. For example, if a user is a member of three group chats, each with different combinations of members, and members of each group chat are planning events, an embodiment maintains three calendars, one for each group chat. One embodiment provides the extracted data to one or more users and asks for confirmation before adding a calendar entry to an interaction-specific calendar. Another embodiment adds a calendar entry automatically, without asking for confirmation.

If an embodiment asks for confirmation before adding a calendar entry to an interaction-specific calendar, and the user provides feedback (e.g., accepting the entry as-is or providing a correction or additional data), an embodiment uses the feedback to adjust the calendar entry. Another embodiment uses the provided feedback to adjust the machine learning model used to extract event data.

An embodiment aggregates one or more interaction-specific calendars into a user-specific calendar. For example, if a user is a member of three group chats, the user-specific calendar includes all the events in all three interaction-specific calendars. Some embodiments include additional controls on the contents of a user-specific calendar, such as including only events a user has accepted, colors or other indications of which interaction is the source of an event, including travel time between events with known locations, and the like.

An embodiment continues to monitor the interaction and, concurrently, uses the machine learning model to extract additional event data from the monitored interaction. If the embodiment determines, using the machine learning model, that the additional event data is an update to an existing calendar entry, the embodiment adjusts the first calendar entry using the second event data. For example, if a group in a group chat decides to change the time of an event, an embodiment might update the calendar entry to indicate the new time. As another example, in a group chat and interaction-specific calendar used to coordinate a group of workers, a message from one worker indicating that a task has been completed, along with the worker’s current location, might be used to trigger assignment of a new task to the worker along with an appropriate calendar entry, while a message from another worker indicating that a task is running long might be used to trigger reassignment of the worker’s next task to a different worker, along with appropriate calendar entries for both.

An embodiment generates an advertisement corresponding to a calendar entry in an interaction-specific calendar for an interaction a user is a member of, and directs the advertisement to the user. For example, if the calendar entry is to meet at a mall at 5pm, an embodiment might generate an advertisement for a store in the mall, to be displayed to the user at 5:10pm, or if the user is a half hour away from the mall at 4:20pm, an embodiment might generate an advertisement for a car service the user could use to get to the mall.

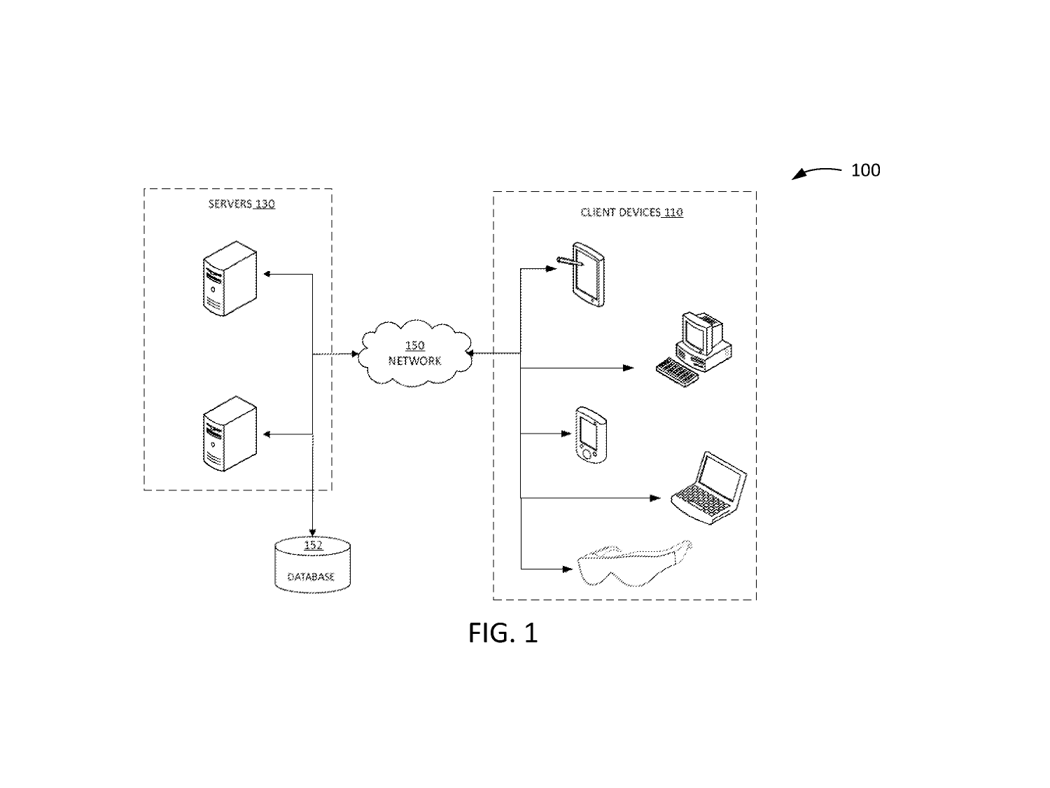

FIG. 1 illustrates a network architecture 100 used to implement automated interaction-specific calendaring within a messaging platform, according to some embodiments. The network architecture 100 may include one or more client devices 110 and servers 130, communicatively coupled via a network 150 with each other and to at least one database 152. Database 152 may store data and files associated with the servers 130 and/or the client devices 110. In some embodiments, client devices 110 collect data, video, images, and the like, for upload to the servers 130 to store in the database 152.

The network 150 may include a wired network (e.g., fiber optics, copper wire, telephone lines, and the like) and/or a wireless network (e.g., a satellite network, a cellular network, a radiofrequency (RF) network, Wi-Fi, Bluetooth, and the like). The network 150 may further include one or more of a local area network (LAN), a wide area network (WAN), the Internet, and the like. Further, the network 150 may include, but is not limited to, any one or more of the following network topologies, including a bus network, a star network, a ring network, a mesh network, and the like.

Client devices 110 may include, but are not limited to, laptop computers, desktop computers, and mobile devices such as smart phones, tablets, televisions, wearable devices, head-mounted devices, display devices, and the like.

In some embodiments, the servers 130 may be a cloud server or a group of cloud servers. In other embodiments, some or all of the servers 130 may not be cloud-based servers (i.e., may be implemented outside of a cloud computing environment, including but not limited to an on-premises environment), or may be partially cloud-based. Some or all of the servers 130 may be part of a cloud computing server, including but not limited to rack-mounted computing devices and panels. Such panels may include but are not limited to processing boards, switchboards, routers, and other network devices. In some embodiments, the servers 130 may include the client devices 110 as well, such that they are peers.

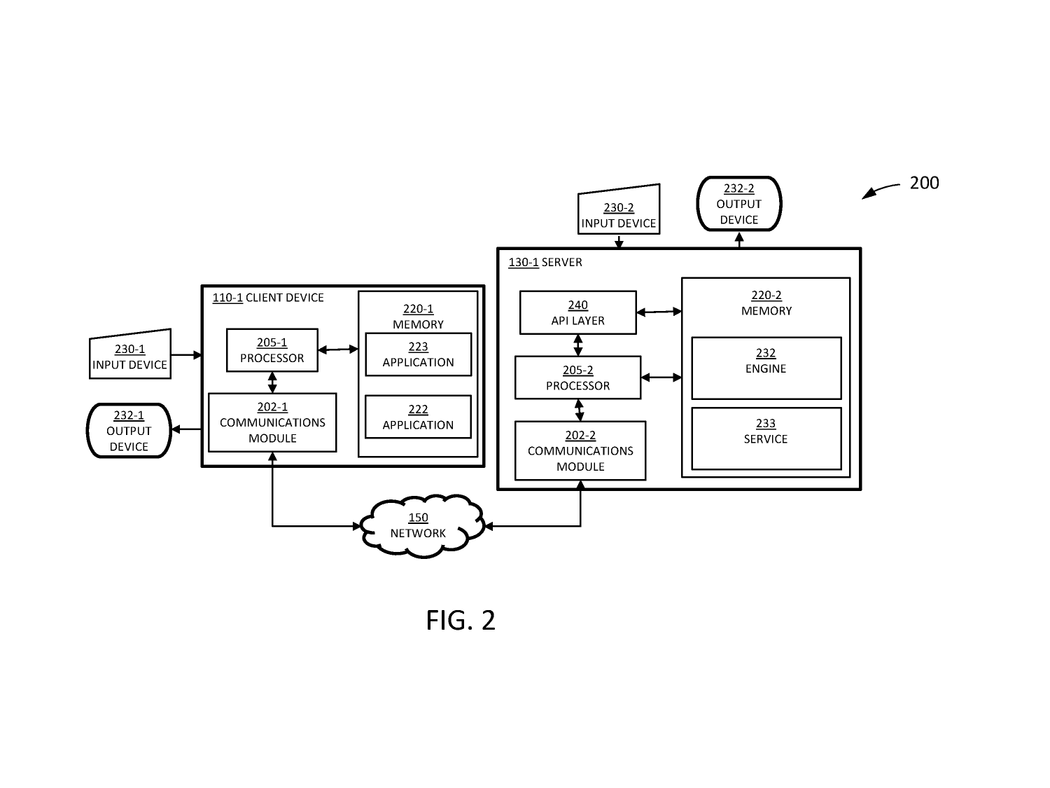

FIG. 2 is a block diagram illustrating details of a system 200 for automated interaction-specific calendaring within a messaging platform, according to some embodiments. Specifically, the example of FIG. 2 illustrates an exemplary client device110-1(of the client devices 110) and an exemplary server 130-1 (of the servers 130) in the network architecture 100 of FIG. 1.

Client device 110-1 and server 130-1 are communicatively coupled over network 150 via respective communications modules 202-1 and 202-2 (hereinafter, collectively referred to as “communications modules 202”). Communications modules 202 are configured to interface with network 150 to send and receive information, such as requests, data, messages, commands, and the like, to other devices on the network 150. Communications modules 202 can be, for example, modems or Ethernet cards, and/or may include radio hardware and software for wireless communications (e.g., via electromagnetic radiation, such as radiofrequency (RF), near field communications (NFC), Wi-Fi, and Bluetooth radio technology).

The client device 110-1 and server 130-1 also include a processor 205-1, 205-2 and memory 220-1, 220-2, respectively. Processors 205-1 and 205-2, and memories 220-1 and 220-2 will be collectively referred to, hereinafter, as “processors 205,” and “memories 220.” Processors 205 may be configured to execute instructions stored in memories 220, to cause client device 110-1 and/or server 130-1 to perform methods and operations consistent with embodiments of the present disclosure.

The client device 110-1 and the server 130-1 are each coupled to at least one input device 230-1 and input device 230-2, respectively (hereinafter, collectively referred to as “input devices 230”). The input devices 230 can include a mouse, a controller, a keyboard, a pointer, a stylus, a touchscreen, a microphone, voice recognition software, a joystick, a virtual joystick, a touch-screen display, and the like. In some embodiments, the input devices 230 may include cameras, microphones, sensors, and the like. In some embodiments, the sensors may include touch sensors, acoustic sensors, inertial motion units and the like.

The client device 110-1 and the server 130-1 are also coupled to at least one output device 232-1 and output device 232-2, respectively (hereinafter, collectively referred to as “output devices 232”). The output devices 232 may include a screen, a display (e.g., a same touchscreen display used as an input device), a speaker, an alarm, and the like. A user may interact with client device 110-1 and/or server 130-1 via the input devices 230 and the output devices 232.

Memory 220-1 may further include an application 222, configured to execute on client device 110-1 and couple with input device 230-1 and output device 232-1, and implement automated interaction-specific calendaring within a messaging platform. The application 222 may be downloaded by the user from server 130-1, and/or may be hosted by server 130-1. The application 222 may include specific instructions which, when executed by processor 205-1, cause operations to be performed consistent with embodiments of the present disclosure. In some embodiments, the application 222 runs on an operating system (OS) installed in client device 110-1. In some embodiments, application 222 may run within a web browser. In some embodiments, the processor 205-1 is configured to control a graphical user interface (GUI) (e.g., spanning at least a portion of input devices 230 and output devices 232) for the user of client device 110-1 to access the server 130-1.

In some embodiments, memory 220-2 includes an application engine 232. The application engine 232 may be configured to perform methods and operations consistent with embodiments of the present disclosure. The application engine 232 may share or provide features and resources with the client device 110-1, including data, libraries, and/or applications retrieved with application engine 232 (e.g., application 222). The user may access the application engine 232 through the application 222. The application 222 may be installed in client device 110-1 by the application engine 232 and/or may execute scripts, routines, programs, applications, and the like provided by the application engine 232.

Memory 220-1 may further include an application 223, configured to execute in client device 110-1. The application 223 may communicate with service 233 in memory 220-2 to provide dynamic user interface generation using large language models. The application 223 may communicate with service 233 through API layer 240, for example.

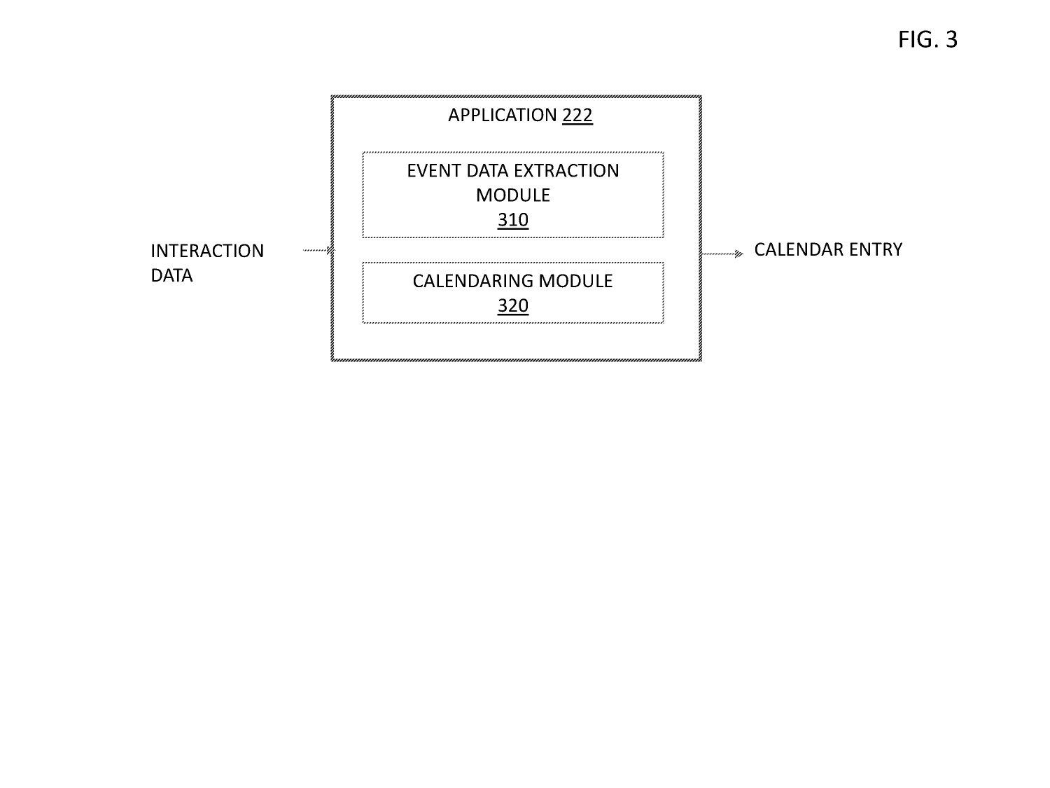

FIG. 3 depicts automated interaction-specific calendaring within a messaging platform, in accordance with an illustrative embodiment. Application 222 is the same as application 222 in FIG. 2.

Event data extraction module 310 monitors an interaction performed within a messaging platform. The interaction is associated with a user of the messaging platform. In one implementation of module 310, the interaction includes content recommended for the user by a recommendation engine of the messaging platform. In another implementation of module 310, the interaction includes content sent via the messaging platform between the user and another user or group of users. In one implementation of module 310, content associated with a user is content the user actually views (both sent and received). In another implementation of module 310, content associated with a user also includes content viewed by an associate of the user (e.g., a direct or higher-degree connection of the user, or another user the first user has previously interacted with). Another implementation of module 310 includes a control with which the user or an administrator can select which content is monitored for analysis and extraction in a manner described herein. Content includes any combination of text and other media (optionally converted to text for monitoring and analysis purposes) for which the user of the messaging platform has opted into the monitoring.

Concurrently with the monitoring, module 310 uses a machine learning model to extract event data from the monitored interaction. Event data is data usable to generate a calendar entry, for example when an event is to occur, where the event is to occur, a topic or purpose of the event, one or more participants in the event, and the like. Machine learning models to convert audio and video to text for analysis are presently available, as are machine learning models to analyze text and extract event data.

Using the extracted event data, calendaring module 320 generates a calendar entry in an interaction-specific calendar maintained within the messaging platform. An interaction-specific calendar is a calendar specific to one interaction on the messaging platform. For example, if a user is a member of three group chats, each with different combinations of members, and members of each group chat are planning events, module 320 maintains three calendars, one for each group chat. One implementation of module 320 provides the extracted data to one or more users and asks for confirmation before adding a calendar entry to an interaction-specific calendar. Another implementation of module 320 adds a calendar entry automatically, without asking for confirmation.

If module 320 asks for confirmation before adding a calendar entry to an interaction-specific calendar, and the user provides feedback (e.g., accepting the entry as-is or providing a correction or additional data), module 320 uses the feedback to adjust the calendar entry. Another implementation of application 222 uses the provided feedback to adjust the machine learning model used to extract event data.

Module 320 aggregates one or more interaction-specific calendars into a user-specific calendar. For example, if a user is a member of three group chats, the user-specific calendar includes all the events in all three interaction-specific calendars. Some implementations of module 320 include additional controls on the contents of a user-specific calendar, such as including only events a user has accepted, colors or other indications of which interaction is the source of an event, including travel time between events with known locations, and the like.

Module 310 continues to monitor the interaction and, concurrently, uses the machine learning model to extract additional event data from the monitored interaction. If module 310 determines, using the machine learning model, that the additional event data is an update to an existing calendar entry, module 320 adjusts the first calendar entry using the second event data. For example, if a group in a group chat decides to change the time of an event, an embodiment might update the calendar entry to indicate the new time. As another example, in a group chat and interaction-specific calendar used to coordinate a group of workers, a message from one worker indicating that a task has been completed, along with the worker’s current location, might be used to trigger assignment of a new task to the worker along with an appropriate calendar entry, while a message from another worker indicating that a task is running long might be used to trigger reassignment of the worker’s next task to a different worker, along with appropriate calendar entries for both.

Application 222 generates an advertisement corresponding to a calendar entry in an interaction-specific calendar for an interaction a user is a member of, and directs the advertisement to the user. For example, if the calendar entry is to meet at a mall at 5pm, an embodiment might generate an advertisement for a store in the mall, to be displayed to the user at 5:10pm, or if the user is a half hour away from the mall at 4:20pm, an embodiment might generate an advertisement for a car service the user could use to get to the mall.

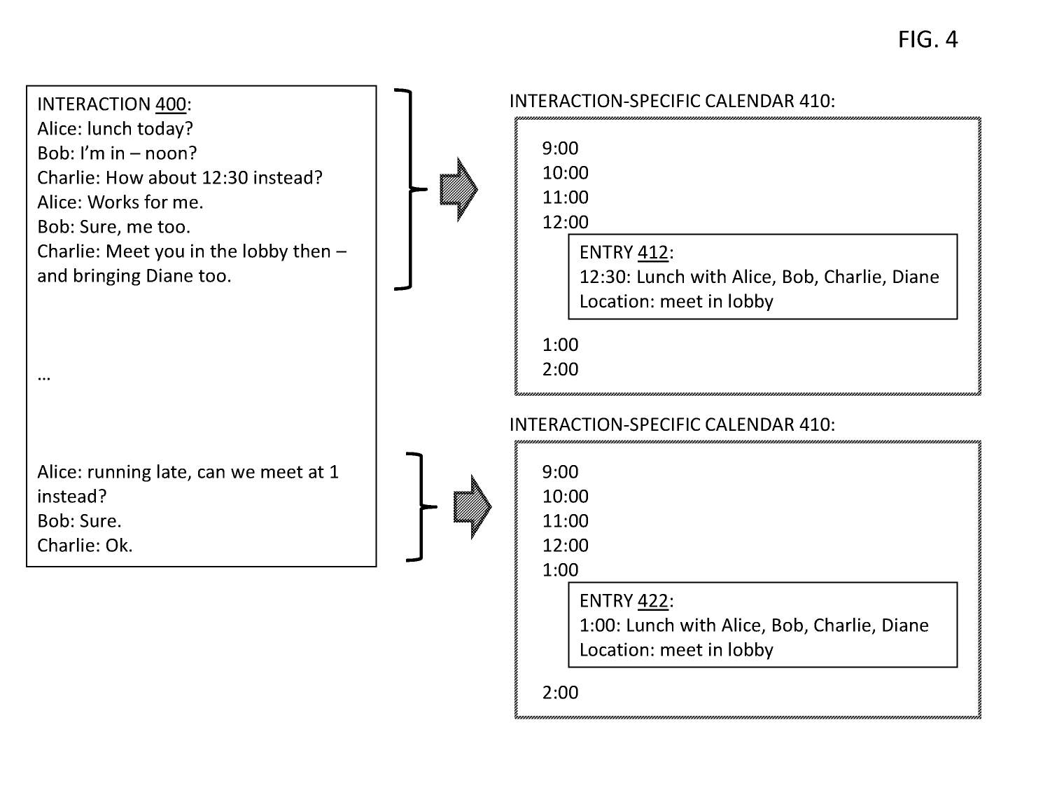

FIG. 4 depicts an example of automated interaction-specific calendaring within a messaging platform, in accordance with an illustrative embodiment. The example can be executed using application 222 in FIG. 2.

Application 222 monitors interaction 400, an interaction performed within a messaging platform. The interaction is associated with a user of the messaging platform – here one of Alice, Bob, Charlie, and optionally Diane. Concurrently with the monitoring, application 222 uses a machine learning model to extract event data from the monitored interaction, and generates calendar entry 412 in interaction-specific calendar 410 maintained within the messaging platform. Application 222 continues to monitor interaction 400 and, concurrently, uses the machine learning model to extract additional event data from the monitored interaction. As depicted, application 222 determines, using the machine learning model, that the additional event data is an update to calendar entry 412, and uses the additional event data to generate calendar entry 422, an adjustment of calendar entry 412.

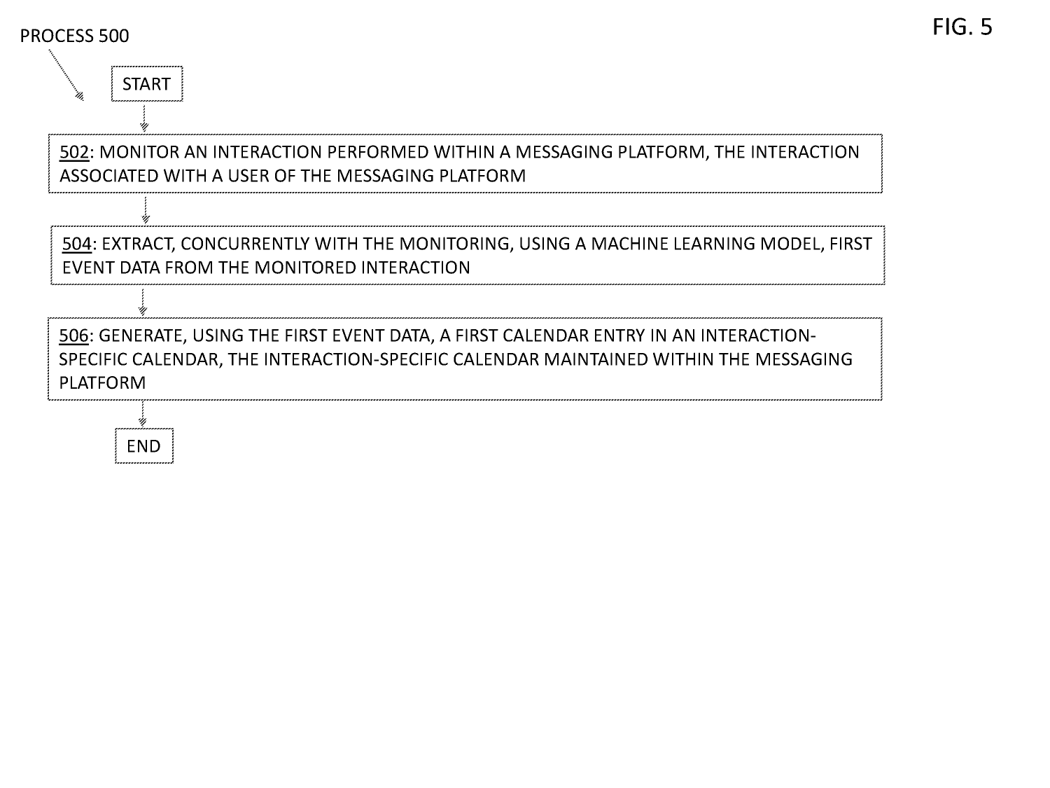

FIG. 5 depicts a flowchart of an example process for automated interaction-specific calendaring within a messaging platform, in accordance with an illustrative embodiment. Process 500 can be implemented in application 222 in FIG. 2.

At block 502, the process monitors an interaction performed within a messaging platform, the interaction associated with a user of the messaging platform. At block 504, the process extracts, concurrently with the monitoring, using a machine learning model, first event data from the monitored interaction. At block 506, the process generates, using the first event data, a first calendar entry in an interaction-specific calendar, the interaction-specific calendar maintained within the messaging platform. Then the process ends.

Many of the above-described features and applications may be implemented as software processes that are specified as a set of instructions recorded on a computer-readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer-readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra-density optical discs, any other optical or magnetic media, and floppy disks. In one or more embodiments, the computer-readable media does not include carrier waves and electronic signals passing wirelessly or over wired connections, or any other ephemeral signals. For example, the computer-readable media may be entirely restricted to tangible, physical objects that store information in a form that is readable by a computer. In one or more embodiments, the computer-readable media is non-transitory computer-readable media, computer-readable storage media, or non-transitory computer-readable storage media.

In one or more embodiments, a computer program product (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more embodiments are performed by one or more integrated circuits, such as application specific integrated circuits (ASICs) or field programmable gate arrays (FPGAs). In one or more embodiments, such integrated circuits execute instructions that are stored on the circuit itself.

The accompanying appendix, which is included to provide further understanding of the subject technology and is incorporated in and constitutes a part of this specification, illustrates aspects of the subject technology and together with the description serves to explain the principles of the subject technology.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon implementation preferences, it is understood that the specific order or hierarchy of blocks in the processes may be rearranged, or that not all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject technology is illustrated, for example, according to various aspects described above. The present disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein may be applied to other aspects.

A reference to an element in the singular is not intended to mean “one and only one” unless specifically stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the disclosure.

To the extent that the terms “include,” “have,” or the like is used in the description or the claims or clauses, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments. In one aspect, various alternative configurations and operations described herein may be considered to be at least equivalent.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the claims or clauses that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user.

Method claims or clauses may be provided to present elements of the various steps, operations, or processes in a sample order, and are not meant to be limited to the specific order or hierarchy presented.

In one aspect, a method may be an operation, an instruction, or a function and vice versa. In one aspect, a claim may be amended to include some or all of the words (e.g., instructions, operations, functions, or components) recited in other one or more claims, one or more words, one or more sentences, one or more phrases, one or more paragraphs, and/or one or more claims.

All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. §112, sixth paragraph, unless the element is expressly recited using the phrase “means for” or, in the case of a method claim, the element is recited using the phrase “step for.”

The Title, Background, and Brief Description of the Drawings of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples, and the various features are grouped together in various embodiments for the purpose of streamlining the disclosure. This method of disclosure is not to be interpreted as reflecting an intention that the included subject matter requires more features than are expressly recited in any claim. Rather, as the claims reflect, inventive subject matter lies in less than all features of a single disclosed configuration or operation. The claims are hereby incorporated into the Detailed Description, with each claim standing on its own to represent separately patentable subject matter.

The claims or clauses are not intended to be limited to the aspects described herein but are to be accorded the full scope consistent with the language of the claims and to encompass all legal equivalents. Notwithstanding, none of the claims are intended to embrace subject matter that fails to satisfy the requirement of 35 U.S.C. § 101, 102, or 103, nor should they be interpreted in such a way.

1. A computer-implemented method comprising monitoring an interaction performed within a messaging platform, the interaction associated with a user of the messaging platform; extracting, concurrently with the monitoring, using a machine learning model, first event data from the monitored interaction; and generating, using the first event data, a first calendar entry in an interaction-specific calendar, the interaction-specific calendar maintained within the messaging platform.

2. The computer-implemented method of claim 1, wherein the interaction comprises content recommended for the user by a recommendation engine of the messaging platform.

3. The computer-implemented method of claim 1, wherein the interaction comprises content sent via the messaging platform between the user and a second user.

4. The computer-implemented method of claim 1, further comprising: aggregating, into a user-specific calendar of the user, the interaction-specific calendar and a second interaction-specific calendar generated from a second interaction associated with the user.

5. The computer-implemented method of claim 1, further comprising: adjusting, using feedback from a user, the first calendar entry.

6. The computer-implemented method of claim 1, further comprising: adjusting, using feedback from a user, the machine learning model.

7. The computer-implemented method of claim 1, further comprising: extracting, using the machine learning model, second event data from the monitored interaction; determining, using the machine learning model, that the second event data is an update to the first calendar entry; and adjusting, responsive to the determining, the first calendar entry using the second event data.

8. The computer-implemented method of claim 1, further comprising: generating an advertisement directed to a user, the advertisement corresponding to the first calendar entry.

9. A non-transitory computer-readable medium storing a program, which when executed by a computer, configures the computer to perform the method of claim 1.

10. A system comprising: a processor; and a non-transitory computer readable medium storing a set of instructions, which when executed by the processor, configure the system to perform the method of claim 1.
